(19) United States
(12) Patent Application Publication
(10) Pub. No.: US 2023/0387475 A1
(43) Pub. Date: Nov. 30, 2023

(54) LITHIUM SUPERCAPATTERY WITH STACKED OR WOUND NEGATIVE AND POSITIVE ELECTRODES SETS ALONG WITH SEPARATOR

(71) Applicant: Indian Space Research Organisation, Bangalore (IN)

(72) Inventors: S A Ilangovan, Thiruvananthapuram (IN); S Sujatha, Thiruvananthapuram (IN); T S Sajitha, Thiruvananthapuram (IN); K S Ajeesh, Thiruvananthapuram (IN); Nixon Jacob, Thiruvananthapuram (IN); Venkateswara Rao Genji, Thiruvananthapuram (IN)

(21) Appl. No.: 18/030,933

(22) PCT Filed: Sep. 25, 2021
(86) PCT No.: PCT/IB2021/058751

§ 371 Date: Apr. 7, 2023

(30) Foreign Application Priority Data
Oct. 8, 2020 (IN) 202041043817

(51) Int. Cl. H01M 10/0587; H01M 10/0525; H01G 11/06; H01G 11/50; H01M 4/583; H01M 10/0569; H01M 4/66; H01G 11/52; H01G 11/28; H01G 11/68

(52) U.S. Cl. CPC H01M 10/0587; H01M 10/0525; H01G 11/06; H01G 11/50; H01M 4/583; H01M 10/0569; H01M 4/661; H01G 11/52; H01G 11/28; H01G 11/68; H01M 2004/027

(57) ABSTRACT

Disclosed herein is a supercapattery that includes a housing having a plurality of negative electrodes and a plurality of positive electrodes, a first porous separator layer placed in between a first negative electrode and a first positive electrode, and a second porous separator layer placed in between a first group of electrodes and a second group of electrodes, the first group of electrodes including the first negative electrode and the first positive electrode, and the second group of electrodes including a second negative electrode and a second positive electrode. At least one negative electrode includes a first current collector coated with a porous layer of an active material of variable thickness on two sides of the current collector. At least one positive electrode includes a second current collector coated with a porous layer of different active materials on two sides of the current collector.

### FIELD

The present disclosure relates to a hybrid energy storage device and, more particularly, to a lithium supercapattery with stacked or wound negative and positive electrodes sets along with separator to address the ever-increasing portable energy storage needs.

### BACKGROUND

Electrochemical energy storage systems such as battery, supercapacitor and fuel cells, form the potential solution to address the ever-increasing portable energy storage needs. Conventional supercapacitors unveil high power density and long cycle life due to their fast kinetics associated with storage mechanisms based on ion adsorption-desorption in electrode/electrolyte interface as reported in literature. On the other hand, lithium based rechargeable batteries offer high energy density but lower power density due to their slow process involving Faradaic reactions in the bulk of electrode active materials. Hybrid capacitors are gaining popularity as they possess advantages of both lithium rechargeable batteries and supercapacitors to large extent.

Hybrid systems are essential to deliver high power/current pulse capable of sustaining repeated cycles meeting various high power applications for Space systems viz., pyro, electromechanical actuators as well as commercial applications viz., electric vehicles, portable electronic devices and so on. Otherwise, such demands are met by employing heavy batteries or external hybridization of battery and supercapacitors. Obviously, such external hybridization imposes heavy penalty on the application due to mass and volume of the energy storage systems (including related control electronics) even though it helps better cycle life when compared to battery alone condition.

The hybridization of both supercapacitors and lithium based batteries to evolve high-energy and high-power electrochemical energy storage devices are reported in various configurations viz. Li-ion capacitors (LICs), Nano Hybrid Capacitors (NRC's) and super redox capacitors. LIC's are composed of a supercapacitor electrode, which is responsible or controls the power capability, and a battery type electrode, which is accountable for the energy delivery. Summarily, in the LICs, the capacity (Ah) is dictated by supercapacitor while the voltage (energy) is governed by lithium or lithium ion electrode (anodes) and the combination suffers from repeated pulse capability for a g⁻¹ ven pulse current and duration.

Various conventional energy storage systems are proposed but the conventional energy storage systems are limited to achieve increased power capability along with high energy density or vice versa, offer only inferior properties, pre-lithiation requirements, etc. In order to overcome these limitations, an innovative internally integrated lithium supercapattery is realized/invented.

### SUMMARY

The principal object of the embodiments herein is to provide an internally integrated lithium supercapattery with stacked or wound anode and cathode electrode sets along with separator having variable electrode dimension that can offer capacity values ranging from 0.5 and 50 Ah. The supercapattery can be assembled in commercially available off the shelf (COTS) capacitor cases which make the overall system cost effective.

Another object of the disclosure is to achieve high performance device with operating voltage ranging from 2.8 V to 4.4V along with high discharge rate capability of 30C to 70C offering high energy densities (˜40 to 80 Wh/kg) and power densities (˜2 to 5 kW/kg), excellent charge retention, low self-discharge and ability to survive extreme electrical, environmental and mechanical conditions.

Still another object of the disclosure is to achieve advantages in terms of mass and volume over batteries, supercapacitors and external hybrid of batteries and supercapacitors.

Yet another object of the disclosure is to avoid pre-lithiation requirement of anode.

Yet another object of the disclosure is to realize an internally integrated lithium supercapattery device with negative electrode comprising of battery anode material on both sides with variable thickness and positive electrode consisting of battery cathode material and supercapacitor material on back to back configuration.

Yet another object of the disclosure is to realize devices which are suitable for variety of applications that require high current for short duration, low current for long duration and combined.

Yet another object of the disclosure is to improve the power capability of the device by varying the electrode characteristics.

Yet another object of the disclosure is realizing an internally integrated supercapattery device assembly in cylindrical configuration in commercially available off the shelf (COTS) capacitor cases (25 mm to 100 mm diameter) thereby lowering production cost.

Yet another object of the disclosure is achieving charge discharge cycling capability>1000 cycles in device level.

In accordance with the aforesaid objects, the present disclosure provides a novel internally integrated lithium supercapattery enabling realization of the above mentioned objects.

In one aspect the object is satisfied by providing a supercapattery includes a housing having a plurality of negative electrode and positive electrode sets, a first porous separator layer placed in between negative electrode and positive in each negative electrode and positive electrode set of the plurality of negative electrode and positive electrode sets, and a second porous separator layer placed in between each two negative electrode and positive electrode set of the plurality of negative electrode and positive electrode sets. The negative electrode comprises a current collector coated with a porous layer of same active material of variable thickness on both sides of the current collector. The positive electrode comprises a current collector coated with a porous layer of different active materials on either sides of the current collector.

In an embodiment, the same active material coated on both sides of the current collector of the negative electrode is a Lithium ion battery anode material.

In an embodiment, the different active materials coated on either sides of the current collector of the positive electrode is a Lithium ion battery cathode material and a supercapacitor activated carbon.

In an embodiment, a thickness of the coating of the negative electrode and the positive electrode is in a range of 150-300 micron.

In an embodiment, the porous separator layer electrically isolate the negative electrode and the positive electrode and acts as a porous medium for ion movement.

In an embodiment, the negative electrode, the positive electrode, the first porous separator layer, and the second porous separator layer are assembled by stacking on each other to get a rectangular shape.

In an embodiment, the negative electrode, the positive electrode, the first porous separator layer, and the second porous separator layer are assembled by winding each other to get a cylindrical shape.

In an embodiment, the assembled the negative electrode, the positive electrode, the first porous separator layer, and the second porous separator layer are inserted into the housing and activated using electrolyte of lithium cation.

In an embodiment, the lithium cation comprises an electrolyte composed of one or more lithium salts dissolved in a mixture of an organic solvent capable of providing required voltage window and operating temperature.

In an embodiment, the current collector of the negative electrode is a Copper foil, and wherein the current collector of the positive electrode is an Aluminum foil.

These and other aspects of the embodiments herein will be better appreciated and understood when considered in conjunction with the following description and the accompanying drawings. It should be understood, however, that the following descriptions, while indicating preferred embodiments and numerous specific details thereof, are g⁻¹ ven by way of illustration and not of limitation. Many changes and modifications may be made within the scope of the embodiments herein without departing from the spirit thereof, and the embodiments herein include all such modifications.

### BRIEF DESCRIPTION OF THE FIGURES

The proposed electrochemical energy storage system called lithium supercapattery is illustrated in the accompanying drawings, throughout which like reference letters indicate corresponding parts in the various figures. The embodiments herein will be better understood from the following description with reference to the drawings, in which:

FIG. 1 illustrates schematic side views of negative and positive electrodes with separator in between towards forming lithium supercapattery, according to embodiments as disclosed herein;

FIG. 2A illustrates a schematic view of the winding process by which properly sized negative and positive electrodes with separator in between are wound into a cell stack, according to embodiments as disclosed herein;

FIG. 2B illustrates a sectional view of the jelly roll/cylindrical structure with separator, negative electrode and positive electrode, according to embodiments as disclosed herein;

FIG. 3A illustrates schematic arrangement of the stacked negative and positive electrodes with separator layer in-between, according to embodiments as disclosed herein;

FIG. 3B is a side view of the pouch/rectangular cell assembly with stacked electrodes and separator; and

FIG. 4 is a graphical representation of a typical charge/discharge cycling pattern, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

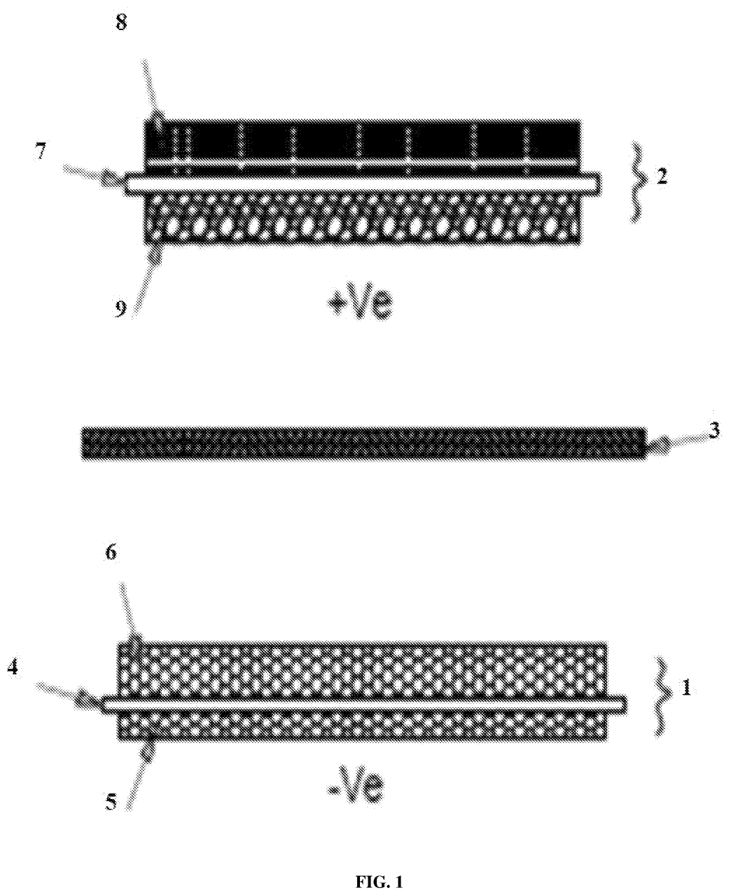

Referring now to the drawings, and more particularly to FIGS. 1-4, there are shown preferred embodiments.

FIG. 1 illustrates schematic side views of negative electrode (1) and positive electrode (2) along with porous separator layer (3) in between towards forming hybrid capacitor, according to embodiments as disclosed herein.

The negative electrode (1) includes a current collector (4) coated with a porous layer of same active material of variable thickness on both sides (5, 6) of the current collector (4) made of Copper foil. In an embodiment, the same active material coated on both sides (5, 6) of the current collector (4) of the negative electrode (1) is a Lithium ion battery anode material. The Lithium ion battery anode materials coated on both sides (5, 6) of the current collector (4) of the negative electrode (1) of variable thickness and is responsible for the charge acceptance and delivery. The positive electrode battery active material (lithium transition metal oxides) allow lithium ions to intercalate reversibly into the graphite electrode, which eliminates the prelithiation requirement of negative electrode and reduces process complexity and results in easy device fabrication in cylindrical configuration. In an embodiment, a thickness of the coating of the negative electrode (1) is in a range of 150-300 micron.

The positive electrode (2) comprises a current collector (7) coated with a porous layer of different active materials on either sides (8, 9) of the current collector (7) made of Aluminum foil. In an embodiment, the different active materials coated on either sides (8, 9) of the current collector (7) of the positive electrode (2) is a Lithium ion battery cathode material and a supercapacitor activated carbon. The Lithium ion battery cathode material is coated on one side (9) that contribute mainly towards the device energy and supercapacitor activated carbon is coated on the other side (8) which is responsible for the power capability. In an embodiment, a thickness of the coating of the positive electrode (2) is in a range of 150-300 micron.

The porous separator layer (3) is placed in between the negative electrode (1) and the positive electrode (2). Further, the porous separator layer (3) electrically isolate the negative electrode (1) and the positive electrode (2) and acts as a porous medium for ion movement.

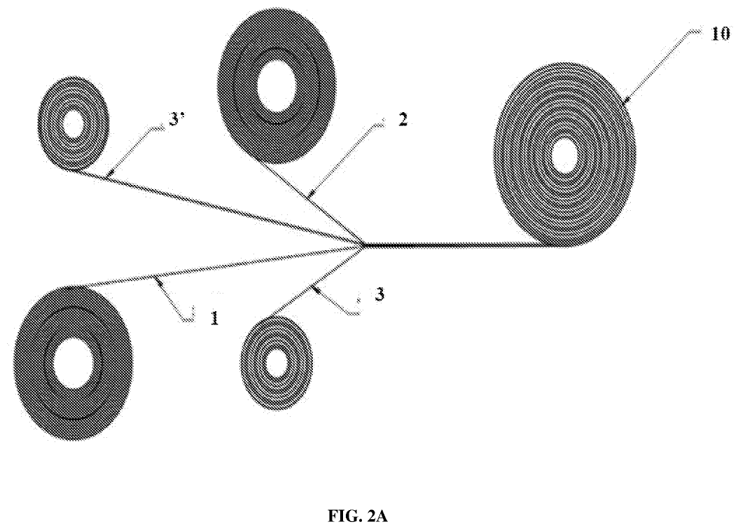

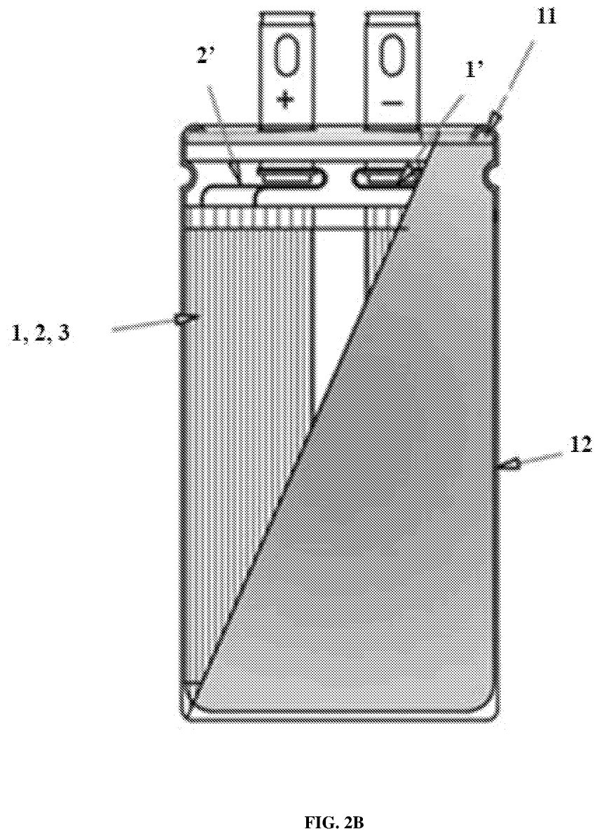

FIG. 2A illustrates a schematic view of the winding process by which properly sized negative and positive electrodes (1, 2) with the porous separator layer (3, 3′) in between are wound into a cell stack (10), according to embodiments as disclosed herein. Two layers of porous separator (3, 3′) are placed in such a way that both sides of negative and positive electrode (1, 2) are separated to avoid any direct electrical contact.

FIG. 2B illustrates a sectional view of the jelly roll/cylindrical structure with the porous separator layer (3, 3′), the negative electrode (1) and the positive electrode (2), according to embodiments as disclosed herein. 1′ (−) and 2′ (+) are the negative and positive terminals attached to the current collectors (4) and (7) respectively, which provide the current path to the terminal from the electrodes extending upwardly within the cell hardware (11, 12).

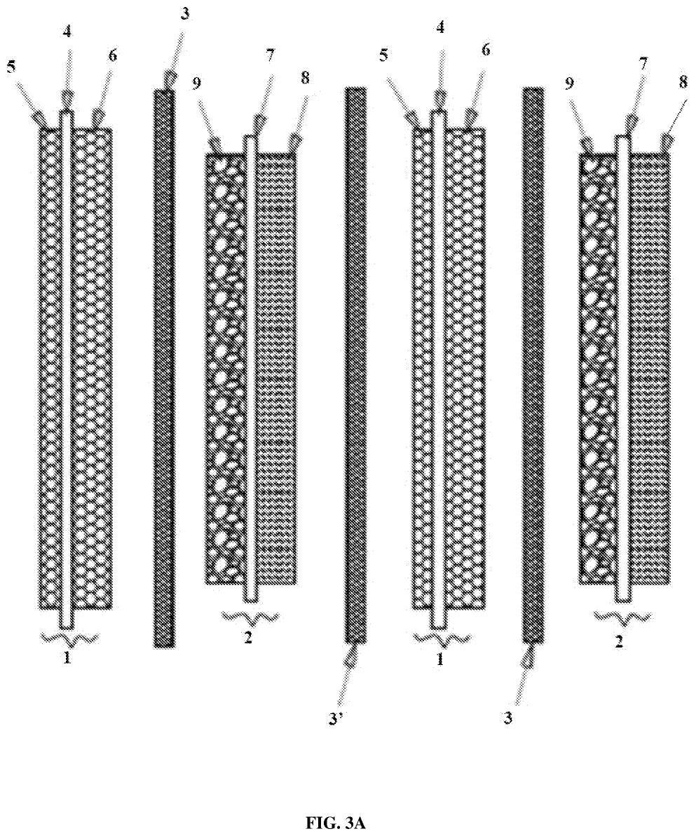

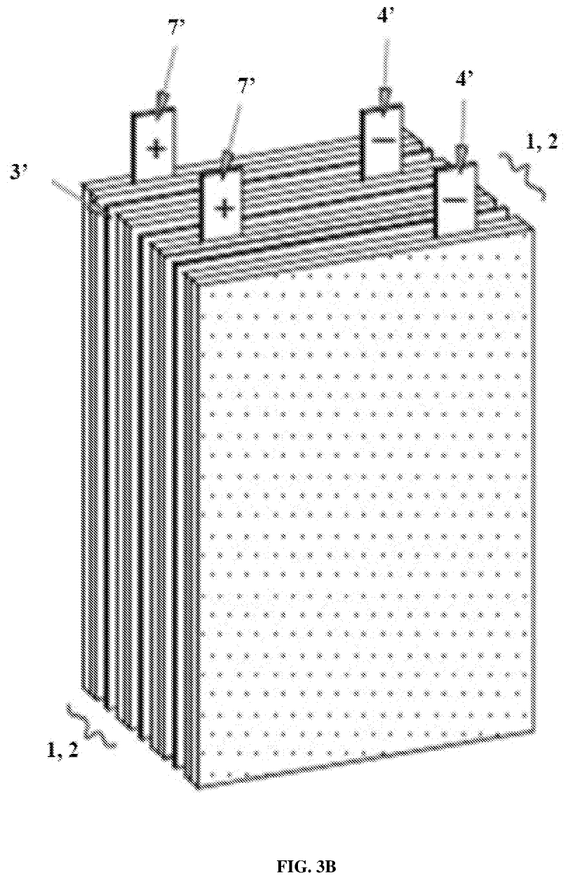

FIG. 3A illustrates schematic arrangement of the stacked negative and positive electrodes (1, 2) with the separator layer (3, 3′) in-between, according to embodiments as disclosed herein. A plurality of negative electrode (1) and positive electrode (2) sets are stacked on each other to get a rectangular shape as shown in the FIG. 3B.

The negative electrode (1) includes of the current collector (4) (e.g. Copper foil), with Lithium ion battery anode materials on both sides (5, 6) and the positive electrode (2) includes the current collector (7) (e.g. Aluminum foil), with the Lithium battery cathode material on side (9) and the Supercapacitor activated carbon on side (8).

FIG. 3B is a side view of the pouch cell assembly with stacked electrodes (1, 2) and separator (3, 3′). The current collector with a connector tab (4′) in negative electrode (1) and connector tab (7′) in positive electrode (2) extending upwardly from the top side of the electrodes arranged in sequence.

Each of the negative electrode (1) is formed out of a copper current collector (4) coated on both sides (5, 6) with a porous layer of active Li-ion battery anode materials and the current collector (7) of the positive electrode (2) is of aluminum/carbon-coated aluminum/etched aluminum with a porous layer of active lithium ion battery cathode materials and supercapacitor activated carbon on side to side. The electrode coating thickness is in the range of 150-300 micron. Both the positive and negative electrode (1, 2) are sized and configured in suitable dimensions to achieve the desired capacity (0.5 to 50Ah) in device level. The device capacity is assessed based on the theoretical capacity of the electrode materials. Each of the positive (2) and negative electrode (1) were assembled alternatively with thin porous separator layer (3) in-between. While assembling, the electrode material mass balancing aspects shall be considered for obtaining the desirable electrochemical performance. The devices are assembled by stacking/winding to get typically rectangular/cylindrical shape. The assembled devices are inserted into a housing and activated using lithium cation containing electrolyte composed of one or more lithium salts (such as Lithium hexafluorophosphate (LiPF6), Lithium tetrafluoroborate (LiBF4), Lithium bis(trifiuoromethanesulfottyl) itnide (LiTFSI), etc.) dissolved in a mixture of organic solvents capable of providing required voltage window and operating temperature for the hybrid device.

In the above-mentioned configuration, substantial reduction in manufacturing cost and time was achieved by providing an internal hybridization with battery electrode making it as the source of lithium, thereby eliminating the additional step for introducing the metallic lithium for sacrificial lithiation, thus making the system safe, simple, cost effective and easy to assemble without employing any sophisticated facilities.

Suitable anode materials are viz., graphite (natural & synthetic), hard carbon, nanosilicon, silicon—graphite composite, etc.; the positive electrode battery material is typically selected from a broad array of lithium containing or lithium intercalated oxides such as lithium manganese oxide, lithium manganese composite oxide, lithium nickel oxide, lithium cobalt oxide, lithium nickel manganese cobalt oxide, lithium vanadium oxide, lithium iron phosphate; and a suitable supercapacitor material is chosen out of activated carbon (derived from petrochemicals and natural resources), mesoporous/porous carbon, carbide derived carbon, CNT, graphene, etc.

While operating the cell, the lithium ions (Lit) intercalate and de-intercalate into the battery anode and cathode alternately and the positive and negative ions from the electrolyte alternately adsorb and desorb on the supercapacitor electrode interface. Operating potential of the device depends on the selected cathode material and electrolyte systems.

The supercapacitor electrode and lithium ion battery electrodes are coated with suitable raw materials along with bonding compounds and conducting carbonaceous additives. Generally, binders are not electrically conductive and should be used in minimal quantities. The raw materials may be dispersed or slurried with a solution of a suitable polymeric binders such as Polyvinylidene Fluoride(PVDF) dissolved in N-methyl-2— Pyrrolidone (NMP)or Carboxy Methyl Cellulose/Styrene Butadiene Rubber resins (CMC/SBR)/Hydroxy Propyl Methyl Cellulose (HPMC) Poly Vinyl Alcohol (PVA)/Polyethylene Oxide (PEO)/Acrylate based co-polymer systems/Polytetrafluoroethylene (PTFE) as an aqueous emulsion, along with conductive carbonaceous additive and applied to a surface of a metallic current collector.

Conducting carbonaceous additives include acetylene black, CNT, graphene, conductive graphite (natural and synthetic), Graphene Nano Platelets (GNP), etc. and any other carbon materials with good electrical conductivity to obtain a durable continuous coated porous electrode with good electrochemical performance. Separator provides electrical insulation between the negative and positive electrodes as well as act as a channel for ion movement. The separator material is a porous layer of a polyolefin, such as Polyethylene (PE), Polypropylene (PP), laminates, PVDF coated poly olefins, ceramic coated poly olefins or treated cellulose based separators, with high electrical resistivity, while retaining the porosity which allows transport of ions between the electrodes. During cell assembly, the positive and negative electrodes are sandwiched between separators of suitable dimension.

The electrolyte for Integral Lithium supercapattery device may be a lithium salt dissolved in one or more organic liquid solvents. Suitable salts include lithium hexa fluorophosphate (LiPF6), lithium tetrafluoroborate (LiBF4), lithium perchlorate (LiClO4), lithium hexafluoro arsenate (LiAsF6), lithium bis(trifluoromethane) sulfonimide (LiTFSI), etc. and solvents that may be used to dissolve the electrolyte salt include organic carbonates such as Ethylene Carbonate (EC), Diethyl Carbonate (DEC), Dimethyl Carbonate (DMC), Ethyl Methyl Carbonate (EMC), Propylene Carbonate (PC), etc.; nitrile based solvents such as Acetonitrile (AN), Adiponitrile (ADN), etc.; and ethers, lactones, sulfolanes, etc. A suitable combination of lithium salt with solvents is selected for obtaining better ionic mobility and transport of lithium ions for the functioning of hybrid device with the battery and supercapacitor electrode combinations. Various additives viz., Vinylene Carbonate (VC), Fluoroethylene Carbonate (FEC), phosphates, borates, etc. are added towards improving the functional properties of electrolytes such as conductivity, viscosity, voltage window, low temperature performance. The electrolyte is carefully introduced into the electrode stack with separator layers for attaining better device performance. The electrode stacks can be assembled in various configurations viz., cylindrical, prismatic, elliptical etc. depending upon the requirements.

An embodiment of the disclosure is as detailed in the following experiment:

### Electrode Processing:

The cathodes were processed by a doctor-blade casting technique. The integral lithium supercapattery consists of a bifunctional cathode with current collector of 5 to 40 μm-thick aluminum foil (purity>99.5%) in which battery side is composed of 50 to 90 wt. % of lithium nickel cobalt manganese oxide, 5 to 25 wt. % of conductive additive and 5 to 25 wt. % PVDF binder with N-Methyl Pyrrolidinone (NMP) as solvent. The other side of cathode is coated with supercapacitor electrode material having 50 to 95 wt. % of AC, 2 to 25 wt. % of conductive additive and 3 to 25 wt. % of CMC/SBR binder with water as solvent. The electrodes were dried under vacuum at 120±10° C.

The anodes were also processed by a doctor-blade casting method. The electrodes consist of 75 −95 wt. % of graphite active materials, 5-25 wt. % poly vinylidene fluoride (PVdF) and N-Methyl Pyrrolidinone (NMP) as solvent. The current collector for anode electrode was 5 to 40 μm-thick high conductive copper foil. The electrodes were dried under vacuum at 120±10° C. Graphite having low negative redox potential (˜0.1 V vs Li), high theoretical capacity (372 mAh g⁻¹ for LiC6 stoichiometry) and relatively low cost, hence it is a widely used anode material in commercial LIBs and LICs. However, the power capabilities of devices are restricted due to the limitations of Li⁺diffusion into the bulk. Since the potential plateau of graphite anode electrode is closer to that of lithium, dendrite formation chances are more at high current charging. The electrode thickness is fine-tuned to improve the capacity and power characteristics of the device that facilitates fast Li-ion diffusion during high rate cycling. In dried electrodes the active material loading on battery side was 3 to 30 mg/cm² and supercapacitor side was 3 to 20 mg/cm².

Device assembly:

The positive and negative electrodes were sized as per dimensions and wound into a jelly roll/jelly flat structure with an insulated separator in between, soaked in electrolyte of lithium salt containing carbonate solvents and sealed into an aluminum-cell case (commercially available capacitor cases)/aluminum pouch. Electrochemical evaluation:

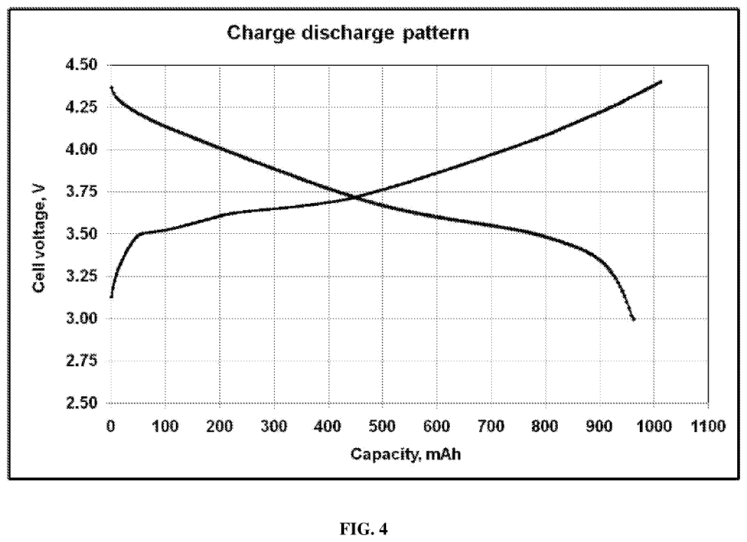

The charge storage mechanism involves lithium intercalation-deintercalation at battery interface and ions adsorption—desorption on electrodes at supercapacitor interface. The lithium intercalation was accomplished by electrochemical charge-discharge process due to graphite anode and lithium metal oxide counter electrode. A stabilized Solid Electrolyte Interphase (SEI) film at graphite anode is ensured by the controlled initial formation cycles at low rate within the voltage window 2.8 to 4.4 V through CC-CV charging. Capacity evaluation of the device is performed at C/2 or 1C rate of the design capacity. The typical charge—discharge cycling pattern is depicted in the FIG. 4. The devices exhibit energy density (˜40 to 80 Wh/kg) and power density (2 to 5 kW/kg).

High rate discharge capability of the devices was also established by carrying out pulse discharge (50C to 70C rates) for short durations (200−500 ms) in the voltage window 4.4 to 2.8V. Devices exhibited>90% capacity retention after Self Discharge Test (SDT) at 3.5 V for 30 days and >80% residual capacity after Charge Retention Test (CRT) in accordance with the standard procedures applicable for space grade Li-ion batteries. Charge-discharge cycling capability (>1000 cycles) with 100% coulombic efficiency at 30 to 50% Depth of Discharge (DOD) and cycles at different State of Charge (SOC) without any memory effect is also the specialty of these devices.

The internally integrated lithium supercapattery executed satisfactorily without any degradation in capacity or voltage at extreme environmental conditions such as (a) thermal test at the temperature range of 5 to 60° C., (b) vibration test at 10 to 15 grms, (c) shock test in the range 50 to 100 g (d) vacuum test to the tune of 10-4 to 10-5 bar and (e) short circuit test, offer confidence in using these devices for many applications.

An internally integrated lithium supercapattery owing to its high energy and power characteristics can be a replacement or complement to battery systems for applications which demand high-current, short-duration and low-current, long-duration requirements. Having considerable mass and volume advantage over battery and supercapacitor, it is an ideal energy/power/storage device for Space applications viz. pyro, electro mechanical actuators, satellite power storage systems etc., bringing down inert mass of launch vehicle and act as suitable cost-effective replacement for batteries in portable hand held devices, power tools, electric vehicles, mobile/cellular devices, etc. As these devices are assembled in commercially available off the shelf (COTS) capacitor cases (25 mm to 100 mm diameter), they can make the system commercial and cost effective. Another advantage of these devices is its easiness in process by eliminating the additional lithiation step/use of Li metal electrode, thus making the system safe, simple, cost effective and easy to assemble without employing any sophisticated facilities.

Unlike the conventional supercapattery, the proposed supercapattery exhibits an energy density of 40 to 80 watt hour/kilogram and a power density of 2 to 5 kW/kg making it suitable for both low current—long duration and high current—short duration applications. The supercapattery offers a charge storage behavior with 90 to 95% charge retention after 80 to100 hours under open circuit conditions and exhibit lowest self-discharge characteristics equivalent to Li-ion cells. The supercapattery offers more than 1000 charge discharge cycles at 30 to 50% depth of discharge. The supercapattery does not possess any memory effect and can perform charge/discharge cycles under any state of charge. The supercapattery can perform in a wide range of temperature 5 to 60° C., sustain vibration in the range of 10 to15 grams, survive shock up to 100g and vacuum level to the tune of 10-4 to 10-5 bar and maintain the device performance after tests without any degradation in capacity or voltage. After short circuit, the supercapattery tests maintain its performance in subsequent cycles with respect to capacity and voltage. The supercapattery specifically suits to space applications viz. pyro, electro mechanical actuators and satellite power storage systems as an ideal power source/storage device. The supercapattery is a cost effective replacement for batteries in portable hand held devices, power tools, electric vehicles and mobile/cellular devices. The supercapattery results in 30 to 50% mass and volume advantage over externally integrated lithium-ion battery and supercapacitor or supercapacitor alone configurations for the said applications. The supercapattery uses electrodes of both lithium-ion cell and supercapacitor wherein the size and thickness of electrodes and the quantity of active materials can be varied to derive desired capacity in ampere hour.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

The following is a list of the reference numerals shown in the Figures:

| Numeral | Description |
|---|---|
| 1 | negative electrode |
| 1′ | negative electrode tab |
| 2 | positive electrode |
| 2′ | positive electrode tab |
| 3 | first porous separator layer |
| 3′ | second porous separator layer |
| 4 | current collector of negative |
| | electrode |
| 4′, 7′ | connector tab |
| 5, 6 | sides of the current collector (4) |
| 7 | current collector of positive electrode |
| 8, 9 | sides of the current collector (7) |
| 10 | cell stack |
| 11, 12 | cell hardware |

1. A supercapattery comprising:
a housing comprising:
a plurality of negative electrode sets comprising a plurality of negative electrodes;
a plurality of positive electrode sets comprising a plurality of positive electrodes;
a first porous separator layer placed in between (i) a first negative electrode in the plurality of negative electrodes, and (ii) a first positive electrode in the plurality of positive electrodes; and
a second porous separator layer placed in between (i) a first group of electrodes, and (ii) a second group of electrodes, the first group of electrodes comprising the first negative electrode and the first positive electrode, and the second group of electrodes comprising a second negative electrode in the plurality of negative electrodes and a second positive electrode in the plurality of positive electrodes,
wherein the first and the second negative electrodes each comprise a first current collector coated with a porous layer of an active material of variable thickness on two sides of the first current collector,
wherein the first and the second positive electrodes each comprise a second current collector coated with a porous layer of different active materials on two sides of the second current collector,
wherein the supercapattery operates between a range of 2.7 to 4.4 Volts with a high discharge rate capability ranging from 50 C to 70 C,
wherein the supercapattery exhibits an energy density of 40 to 80 Wh/kg and a power density of 2 to 5 kW/kg, thereby making it the supercapattery suitable for both low current-long duration and high current-short duration applications,
wherein the supercapattery can be assembled in commercially available capacitor cases having a diameter of between 25 mm to 180 mm, thereby making the supercapattery low cost and/or cost effective.

2. The supercapattery as claimed in claim 1, wherein the same active material is a Lithium ion battery anode material.

3. The supercapattery as claimed in claim 1, wherein the different active materials are a Lithium ion battery cathode material, and a supercapacitor activated carbon, respectively.

4. The supercapattery as claimed in claim 1, wherein a thickness of a coating of each of the plurality of negative electrodes is in a range of 150 to 300 microns, and a thickness of a coating of each of the plurality of positive electrodes is in the range of 150 to 300 microns.

5. The supercapattery as claimed in claim 1, wherein the first porous separator layer electrically isolates the first negative electrode and the first positive electrode, wherein the second porous separator layer electrically isolates the first group of electrodes and the second group of electrodes, and wherein each of the first and the second porous separator layers acts as a porous medium for ion movement.

6. The supercapattery as claimed in claim 1, wherein the at least one negative electrode, at least one positive electrode, the first porous separator layer, and the second porous separator layer are assembled together by stacking to produce an assembly with a rectangular shape.

7. The supercapattery as claimed in claim 1, wherein at least one negative electrode, at least one positive electrode, the first porous separator layer, and the second porous separator layer are assembled together by winding to produce an assembly with a cylindrical shape.

8. The supercapattery as claimed in claim 6, wherein the assembly is inserted into the housing and activated using a lithium cation.

9. The supercapattery as claimed in claim 8, wherein the lithium cation comprises an electrolyte composed of one or more lithium salts dissolved in a mixture of an organic solvent capable of providing a required voltage window and operating temperature.

10. The supercapattery as claimed in claim 1, wherein the first current collector is a Copper foil, and wherein the second current collector is an Aluminum foil.

11. The supercapattery as claimed in claim 1, wherein the supercapattery has charge storage behavior with 90 to 95% charge retention after 80 to 100 hours under open circuit conditions and exhibits lowest self-discharge characteristics equivalent to Lithium-ion cells.

12. The supercapattery as claimed in claim 1, wherein the supercapattery can perform more than 1000 charge/discharge cycles at 30 to 50% depth of discharge.

13. The supercapattery as claimed in claim 1, wherein the supercapattery does not possess any memory effect and can perform one or more charge/discharge cycles under any state of charge.

14. The supercapattery as claimed in claim 1, wherein the supercapattery can (i) perform in a temperature range of between 5° C. to 60° C., (ii) sustain vibration in a range of 10 to 15 gₘₛ, (iii) survive a shock up to 100g and a vacuum level of 10⁻⁴ to 10⁻⁵ mbar, while maintaining performance without any degradation in capacity or voltage.

15. The supercapattery as claimed in claim 1, wherein the supercapattery is configured to be used as a power source/storage device in one or more outer space devices selected from the group consisting of: one or more pyro actuators, one or more electromechanical actuators, and one or more satellite power storage systems, and wherein the supercapattery is a cost effective replacement for batteries in a device selected from the group consisting of: one or more portable handheld devices, one or more power tools, one or more electric vehicles, and one or more mobile/cellular devices.

16. The supercapattery as claimed in claim 15, wherein the supercapattery results in a 30 to 50% mass and volume advantage compared to (i) an externally integrated lithium-ion battery and supercapacitor, or (ii) a supercapacitor alone.

17. The supercapattery as claimed in claim 1, wherein the supercapattery uses electrodes of both lithium-ion cells and supercapacitors, wherein a size and thickness of the electrodes, and a quantity of active materials, can be varied to derive desired capacity in Ah.

18. The supercapattery as claimed in claim 1, wherein the different active materials comprise lithium transition metal oxides that allow lithium ions to intercalate reversibly into a graphite electrode, thereby eliminating a pre-lithiation requirement of each of the plurality of negative electrodes, reducing process complexity, and resulting in easy device fabrication in a cylindrical configuration.

19. The supercapattery as claimed in claim 7, wherein the assembly is inserted into the housing and activated using a lithium cation.

20. The supercapattery as claimed in claim 19, wherein the lithium cation comprises an electrolyte composed of one or more lithium salts dissolved in a mixture of an organic solvent capable of providing a required voltage window and operating temperature.
